(19) United States
(12) Patent Application Publication
(10) Pub. No.: US 2018/0096179 A1
(43) Pub. Date: Apr. 5, 2018

(54) MEDICAL ASSET SENSING AND TRACKING

(71) Applicant: International Business Machines Corporation, Armonk, NY (US)

(72) Inventors: BING DANG, Chappaqua, NY (US); LI-WEN HUNG, Mahopac, NY (US); JOHN U. KNICKERBOCKER, Yorktown Heights, NY (US); SHRIYA KUMAR, Yorktown Heights, NY (US); DUIXIAN LIU, Scarsdale, NY (US); ENRIQUE VARGAS, Bronx, NY (US)

(21) Appl. No.: 15/285,857

(22) Filed: Oct. 5, 2016

(51) Int. Cl. G06K 7/10

(52) U.S. Cl. CPC G06K 7/10366; G06K 7/10316

(57) ABSTRACT

Embodiments include systems, methods, and computer program products for tracking and sensing medical assets. Systems include a plurality of long range transmitters. Systems also include a medical asset box including a medical asset, a radio frequency ID microchip in proximity to the medical asset, and an extended antenna that is capable of receiving a signal from the radio frequency ID microchip and transmitting the signal to an external device.

### BACKGROUND

The present invention relates generally to sensing and tracking medical assets, and more specifically to methods, systems, and computer program products for sensing and tracking medical assets, such as surgical instruments and implant components, within medical facilities.

Medical assets, such as surgical instruments and implant components are distributed in hospitals worldwide. In some cases, costly medical assets are not owned by the hospitals and are, instead, leased. Throughout their use, medical assets can be moved between hospitals. In addition, the medical assets can be moved frequently within a hospital, for example, between operation rooms, storage rooms, and sterilization locations. Medical assets are frequently stored in metal containers, including hermetically sealed containers. Such containers, and the assets within the containers, can be subjected to extreme conditions, such as high temperatures, as they are sterilized and prepared for use.

### SUMMARY

In accordance with one or more embodiments, a system for tracking medial assets includes a plurality of long-range transmitters. The system also includes a medical asset box, the medical asset box including a medical asset, a radio frequency ID microchip positioned within an interior of the medical asset box, and an extended antenna positioned on an exterior of the medical asset box, wherein the extended antenna is capable of receiving a signal from the radio frequency ID microchip and transmitting the signal to an external device.

In accordance with another embodiment, a medical asset tag for tracking medical assets includes a radio frequency signal. The medical asset tag also includes a high temperature battery. The medical asset tag also includes an antenna. The medical asset tag also includes a motion sensor. The medical asset tag also includes a control circuit. The medical asset tag also includes a memory in communication with the control circuit.

In accordance with a further embodiment, a computer program product for tracking medical assets includes a computer readable storage medium having stored thereof first program instructions executable by a processor to cause the device to receive a unique identifier from a radio frequency signal of a medical asset tag. The instructions executable by the processor also cause the device to associate the unique identifier with a medical asset location to generate a medical asset data packet. The instructions executable by the processor also cause the device to output the medical asset data packet to a gateway.

### BRIEF DESCRIPTION OF THE DRAWINGS

The subject matter of embodiments of the invention is particularly pointed out and distinctly claimed in the claims at the conclusion of the specification. The foregoing and other features and advantages of the one or more embodiments described herein are apparent from the following detailed description taken in conjunction with the accompanying drawings in which:

FIG. 1 depicts a cloud computing environment according to one or more embodiments of the present invention.

FIG. 2 depicts abstraction model layers according to one or more embodiments of the present invention.

FIG. 3 is a computer system according to one or more embodiments of the present invention.

FIG. 4 illustrates an exemplary system for sensing and tracking medical assets according to one or more embodiments of the present invention.

FIGS. 5A-5C illustrate exemplary medical asset boxes according to one or more embodiments of the present invention, in which:

FIG. 5A illustrates a medical asset box with a top antenna;

FIG. 5B illustrates a medical asset box with side antennas; and

FIG. 5C illustrates a medical asset box with omni-directional antenna.

FIG. 6 illustrates a network for sensing and tracking medical assets according to one or more embodiments of the present invention.

FIG. 7 illustrates an independent wireless sensor network according to one or more embodiments of the present invention.

FIG. 8 illustrates a system for medical instrument tracking according to one or more embodiments of the present invention.

FIG. 9 is a flow diagram illustrating a method for medical instrument tracking according to one or more embodiments of the present invention.

### DETAILED DESCRIPTION

It is understood in advance that although this description includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure including a network of interconnected nodes.

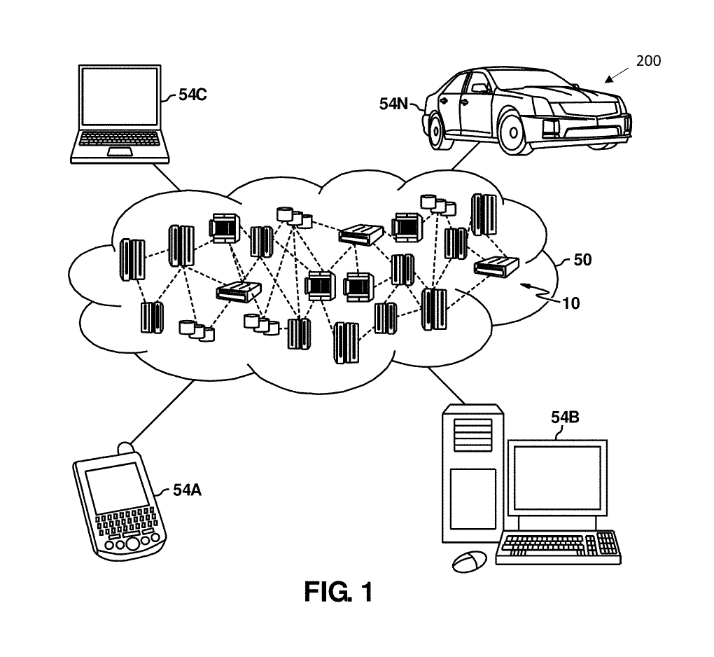

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N can communicate. Nodes 10 can communicate with one another. They can be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

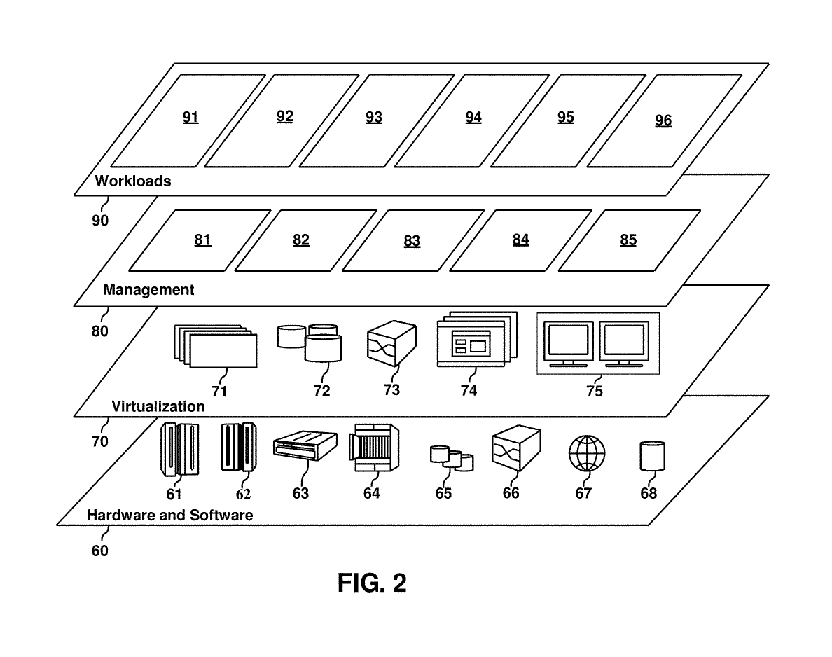

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one example, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment can be utilized. Examples of workloads and functions which can be provided from this layer include: mapping and navigation 91; software development and lifecycle management 92; virtual classroom education delivery 93; data analytics processing 94; transaction processing 95; and sensing and tracking medical assets 96.

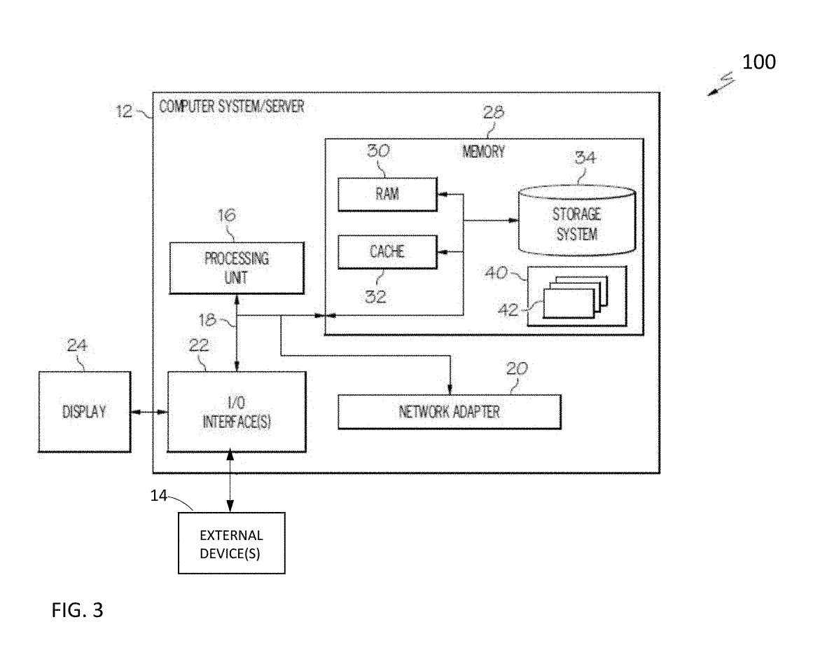

Referring now to FIG. 3, a schematic of a cloud computing node 100 included in a distributed cloud environment or cloud service network is shown according to a non-limiting embodiment. The cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 12, which is operational with numerous other general purpose or special purpose computing system environments or configurations. Examples of well-known computing systems, environments, and/or configurations that can be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 can be described in the general context of computer system-executable instructions, such as program modules, being executed by a computer system. Generally, program modules can include routines, programs, objects, components, logic, data structures, and so on that perform particular tasks or implement particular abstract data types. Computer system/server 12 can be practiced in distributed cloud computing environments where tasks are performed by remote processing devices that are linked through a communications network. In a distributed cloud computing environment, program modules can be located in both local and remote computer system storage media including memory storage devices.

As shown in FIG. 3, computer system/server 12 in cloud computing node 100 is shown in the form of a general-purpose computing device. The components of computer system/server 12 can include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media can be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 can include at least one program product having a set (e.g., at least one) of program modules that are configured to carry out the functions of embodiments of the invention.

Program/utility 40, having a set (at least one) of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the invention as described herein.

Computer system/server 12 can also communicate with one or more external devices 14 such as a keyboard, a pointing device, a display 24, etc., one or more devices that enable a user to interact with computer system/server 12, and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

Turning now to an overview of aspects of the present invention, systems and methodologies for sensing and tracking medical assets are provided for medical assets, such as surgical instruments, implant components, and other medical devices. In addition to movement between facilities, medical assets are frequently moved within a given facility as the assets undergo storage, sterilization, and are implemented in various medical procedures. Embodiments allow sensing and tracking of medical assets within a given facility or between facilities while maintaining the assets within a sterilizable and transportable box. In some embodiments, medical assets are sensed and tracked through sterilization procedures, which can subject the medical assets to harsh temperatures (for instance 120° C. or higher) or chemical conditions.

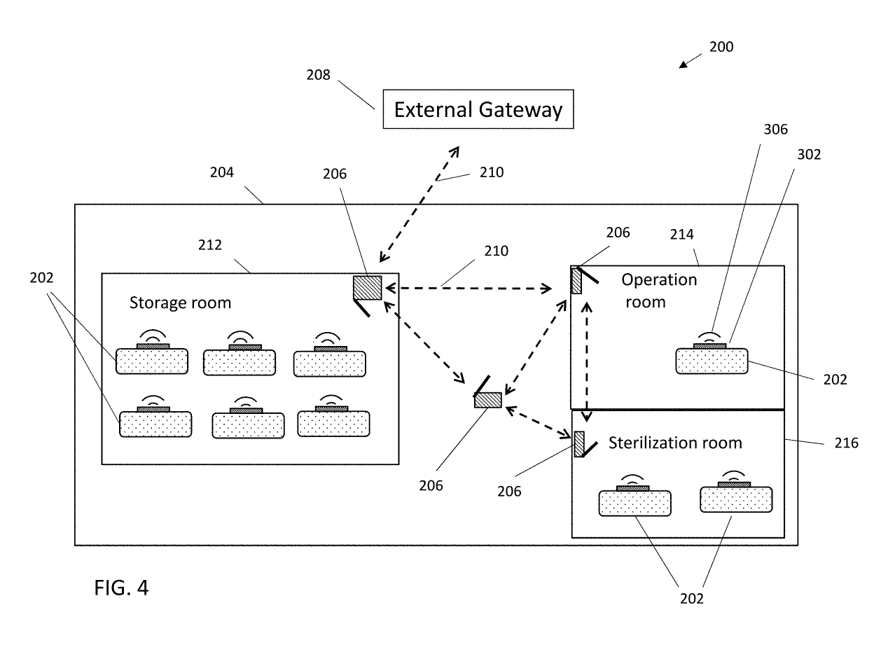

Turning now to a more detailed description of one or more embodiments, FIG. 4 illustrates an exemplary system for sensing and tracking medical assets 200 according to one or more embodiments. The exemplary system 200 includes a plurality of medical asset boxes 202. The medical asset boxes 202 can include a metal housing, such as stainless steel. The medical asset boxes 202 include an extended antenna 302 that transmits a wireless signal 306. In some embodiments, antenna 302 is a FCC compliant high performance ISM (industrial, scientific and medical) band antenna. The medical asset boxes 202 can be situated in a medical facility 204. For instance, medical asset boxes 202 can be situated in a storage room 212, operation room 214, or sterilization room 216. The system also includes a plurality of long range transmitters 206 and an external gateway 208. In some embodiments, not shown, the system does not include an external gateway 208. The long range transmitters 206 can be positioned throughout the medical facility 204. The long range transmitters 206 can receive a signal from a medical asset box 202 in proximity to one of long range transmitters 206. The presence of a signal or the strength of a signal received by a long range transmitter 206 can provide positional information regarding a medical asset box 202 to allow sensing and tracking of medical assets. In some embodiments, the system includes a communication link 210 between the long range transmitters 206 and between the long range transmitters 206 and the external gateway 208. The communication link 210 can be wired or wireless and can include a cellular, Wi-Fi, or Ethernet connection. In some embodiments, the communication link 210 is inaccessible from a network of the medical facility 204. In some embodiments, the communication link 210 is accessible from a network of the medical facility 204.

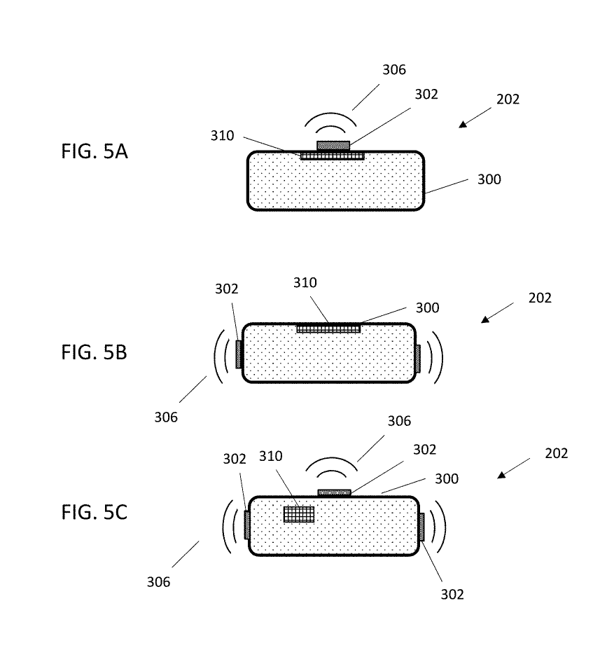

Medical asset boxes 202 can have a variety of antenna configurations. FIGS. 5A-5C illustrate top down cross sectional views of exemplary medical asset boxes 202 according to one or more embodiments. As is illustrated in FIG. 5A, a medical asset box 202 can include a metal housing 300 and an antenna 302. The antenna 302, as illustrated in FIG. 5A, can be a top antenna, radiating a wireless signal 306 in an upward vertical direction. The medical asset box 202 can have a unique identifier within the housing to sense or track a medical asset. In some embodiments, the medical asset box 202 includes a RF ID chip 310. The RF ID chip 310 can be fastened to the interior of the medical asset box 202, for instance, on the metal housing 310. In some embodiments, a medical asset box 202 has one antenna 302. In some embodiments, a medical asset box 202 has a plurality of antenna 302. FIG. 5B illustrates a medical asset box 202 having two side antennas 302, the side antennas radiate a wireless signal 306 outward from the medical asset box in horizontal directions. As is shown in FIG. 5C, a medical asset box can have multiple antennas 302, including a plurality of antennas 302 radiating a wireless signal 306 for omni-directional coverage. In some embodiments, as is shown in FIG. 5C, an RF ID chip 310 is situated within the housing 300 but not attached to the housing 300.

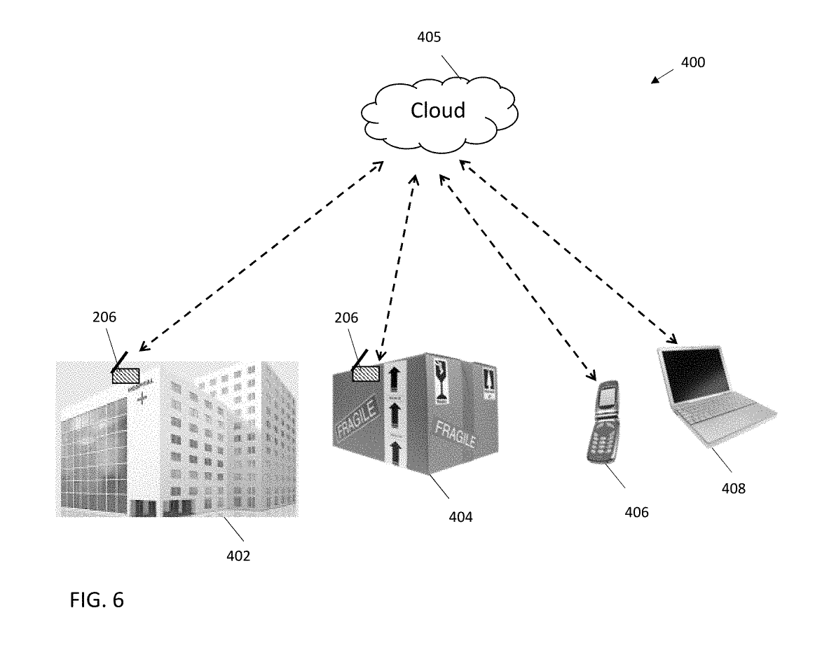

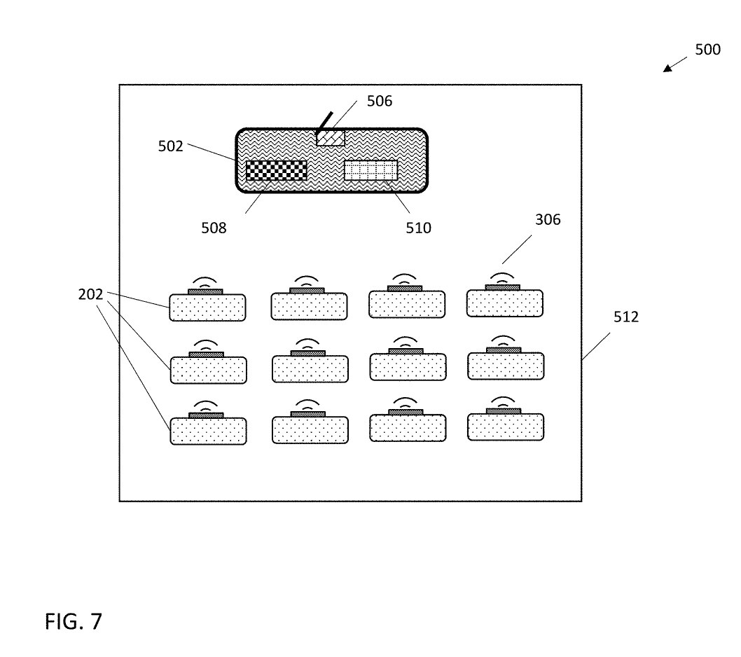

Systems for instrument tracking and sensing can be implemented to track medical assets within a single facility or across multiple facilities. FIG. 6 illustrates a wireless sensor network for tracking medical assets across multiple facilities (WSN) 400 according to one or more embodiments. In some embodiments, the WSN 400 is used to sense and track medical assets across multiple facilities. For example, a medical facility 402 or a medical asset transport package 404 can contain a long range transmitter 206. The long range transmitters 206 can wirelessly communicate with a wireless sensor network 405. The independent wireless sensor network 400 can also include mobile devices 406, such as smart phones, tablets, smart watches, and the like, in communication with the cloud 405. The WSN 400 can also include computing devices 408 with wireless communication capabilities, such as laptop computers and desktop computers. The computing devices 408 and mobile devices 406 can send or receive data through the cloud 405 to other systems and devices in the network. For example, a mobile device 406 can be used to determine what medical assets are in transit, for example in a particular asset transport package 404 and what medical assets are located in a medical facility 402. In some embodiments, data is encrypted prior to sending to the cloud 405. In some embodiments, data is decrypted upon receipt from the cloud 405. Data can be transmitted to and from the cloud 405 with a cellular, WiFi, or Ethernet connection.

In some embodiments, systems for tracking medical assets include an independent wireless sensor network 500. An independent wireless sensor network 500 includes, in some embodiments, a controller box 502. The controller box 502 can include a battery 508, a controller box gateway 506, and a tag manager 510. In some embodiments, battery 508 includes a large capacity rechargeable battery pack. In some embodiments, the controller box gateway 506 includes a wireless gateway, such as a cellular, WiFi, or Ethernet gateway. The controller box 502 can be situated in an enclosed space 512, such as a storage room or shipping container. The controller box gateway 506 can communicate with devices within the enclosed space 512. In some embodiments, the controller box gateway 506 communicates with devices external to the enclosed space 512. The tag manager 510 can receive a wireless signal 306 from a plurality of medical asset boxes 202 within the enclosed space 512. In some embodiments, the tag manager 510 can identify particular medical assets within the enclosed space based upon a wireless signal 306 received from a medical asset box 202. The tag manager 510 can be programmed to receive data continuously or periodically from devices within the enclosed space 512. The controller box gateway 506 can receive and transmit data identifying medical asset boxes 202 within the enclosed space 512 to external devices.

In some embodiments, medical asset boxes 202 include a medical asset. In some embodiments, medical asset boxes 202 include a plurality of medical assets. In some embodiments, medical assets are identified and tracked based upon the identification of the medical asset box 202. For example, the medical asset box 202 can include an RF ID chip 310 affixed to the medical asset box 202. In some embodiments, a medical asset or a plurality of medical assets, such as medical instruments, is individually identified and tracked.

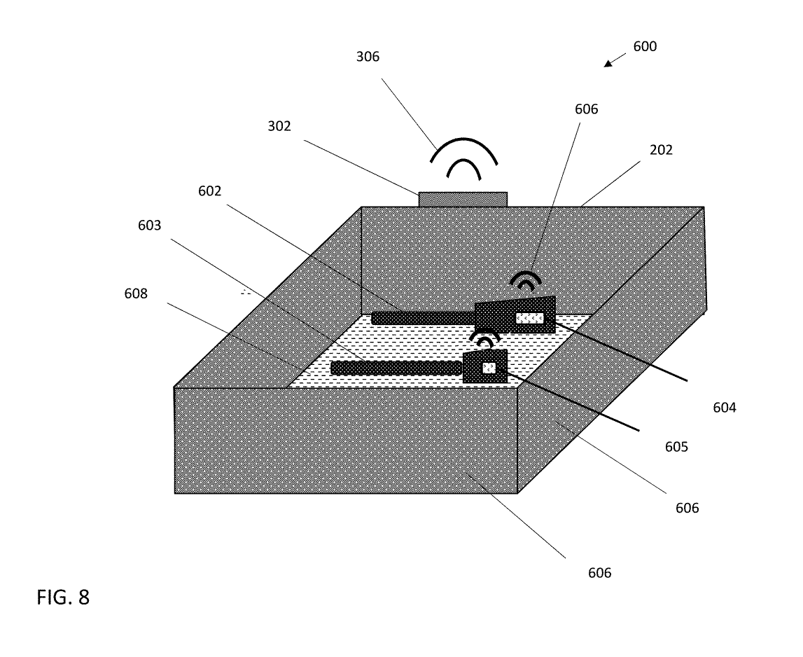

FIG. 8 illustrates a system for medical instrument tracking 600 according to one or more embodiments. The system 600 includes a medical asset box 202 including a plurality of sidewalls 606 and a bottom supporting surface 608. The medical asset box can contain a plurality of medical instruments 602, 603. The medical instruments 602, 603 can each include a medical asset tag including a micro RF ID 604, 605. The micro RF ID 604, 605 can be embedded or attached to the instruments 602, 603. In some embodiments, the micro RF ID 604, 605 uniquely identifies a medical instrument 602, 603. In some embodiments, the micro RF ID 604, 605 is water resistant. In some embodiments, the micro RF ID 604, 605, emits a radio frequency signal 606. In some embodiments, a radio frequency signal 606 provides identification information for a medical instrument 602 or 603, which identification information can be wirelessly transmitted by an antenna 302 to another device.

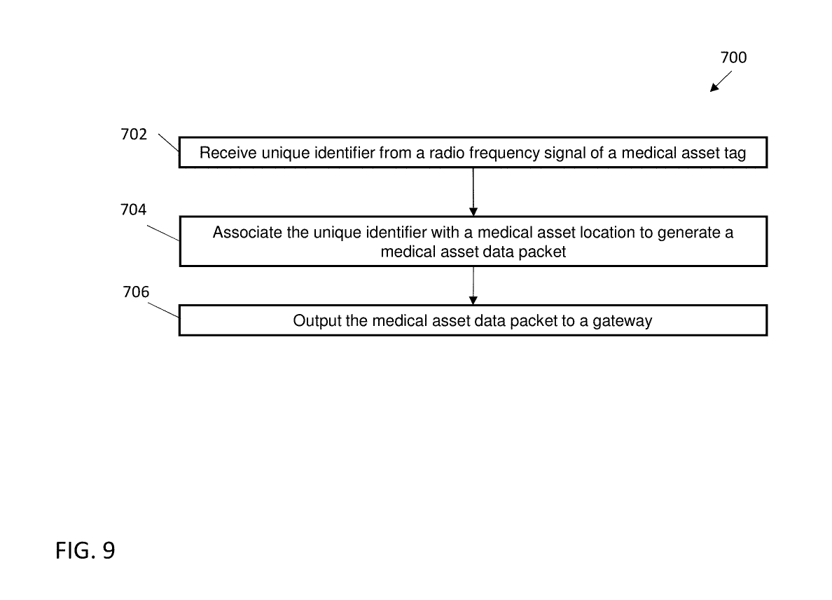

FIG. 9 depicts a flow diagram of a method 700 for medical instrument tracking according to one or more embodiments. The method 700 includes receiving a unique identifier from a radio frequency signal of a medical asset tag, as is shown at block 702. The method 700 also includes associating the unique identifier with a medical asset location to generate a medical asset data packet, as is shown at block 704. The method 700 also includes outputting the medical asset data packet to a gateway, as is shown at block 706.

In some embodiments, an RF ID or a micro RF ID is hermetically sealed. In some embodiments, an RF ID or a micro RF ID includes a battery, such as a high temperature battery. In some embodiments an RF ID or a micro RF ID includes an integrated antenna. In some embodiments, an RF ID or a micro RF ID includes an extended antenna. In some embodiments, an RF ID or a micro RF ID includes a motion sensor. In some embodiments, an RF ID or a micro RF ID includes a temperature sensor. In some embodiments, an RF ID or a micro RF ID includes an integrated circuit, such as a control circuit. In some embodiments, an RF ID or a micro RF ID includes memory.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form described. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A system for tracking medical assets, the system comprising:
a plurality of long range transmitters in communication with a wireless sensor network and a medical asset box, the medical asset box comprising:
a medical asset comprising a medical device enclosed within the medical asset box;
a medical asset tag comprising radio frequency ID microchip in proximity to the medical asset; and
an extended antenna positioned on an exterior of the medical asset box, wherein the extended antenna is capable of receiving a signal from the radio frequency ID microchip and transmitting the signal to an external device via the plurality of long range transmitters.

2. The system of claim 1, wherein the wireless sensor network comprises a cellular, Wi-Fi, or Ethernet connection in communication with an external device.

3. The system of claim 1, wherein the wireless sensor network is a closed network independent from a facility network.

4. The system of claim 1, wherein the radio frequency ID microchip is positioned within an interior of the medical asset box.

5. The system of claim 1, wherein the radio frequency ID microchip is positioned on an exterior of the medical asset box.

6. The system of claim 1, wherein the antenna comprises an omni-directional antenna.

7. The system of claim 1, wherein the radio frequency ID microchip is attached to the medical asset.

8. The system of claim 1, wherein the radio frequency ID microchip is water resistant.

9. The system of claim 1 further comprising a controller box.

10. The system of claim 9, wherein the controller box comprises:
a tag manager in communication with the medical asset box capable of being programmed to receive data continuously or periodically;
a battery providing power to the tag manager; and
a wireless gateway in communication with the tag manager and an external device.

11. (canceled)

12. The system of claim 10, wherein the wireless gateway comprises a cellular, Wi-Fi, or Ethernet connection.

13. The system of claim 10, wherein the battery is hermetically sealed.

14. The system of claim 10, wherein the battery is rechargeable.

15. A medical asset tag for tracking medical assets, the medical asset tag comprising:
a radio frequency signal generated by an RF ID attached to a medical asset, wherein the radio frequency signal is in proximity to and in communication with an extended antenna on a medical asset box in communication with a wireless sensor network, and wherein the radio frequency signal transmits a medical asset data packet comprising a unique identifier for the medical asset to the antenna;
a high temperature battery positioned within the RF ID for supplying power to the medical asset tag;
a motion sensor positioned within the RF ID for generating a RF ID location;
a control circuit in communication with the RF ID and the high temperature battery, wherein the control circuit is capable of associating the unique identifier with the RF ID location to generate the medical asset data packet; and
a memory in communication with the control circuit.

16. The medical asset tag of claim 15, wherein the extended antenna communicates with an external device through the wireless sensor network.

17. A computer program product for tracking medical assets,
a computer readable storage medium having program instructions embodied therewith, wherein the instructions are executable by a processor to cause the processor to perform a method comprising:
receiving a unique identifier from a radio frequency signal of a medical asset tag affixed to a medical asset comprising a medical device enclosed within a medical asset box, wherein the unique identifier uniquely identifies the medical asset;
associating the unique identifier with a medical asset location to generate a medical asset data packet, wherein the medical asset location is determined based upon the presence of a signal or a strength of the signal received to a long range transmitter from the medical asset box; and
outputting the medical asset data packet to a gateway.

18. The computer program product of claim 17, wherein the method comprises encrypting the medical asset data packet.

19. The computer program product of claim 17, wherein the medical asset data packet comprises motion sensor data.

20. The computer program product of claim 17, wherein software is provided as a service in a cloud environment.

21. The system of claim 1, wherein the medical asset comprises a surgical instrument or implant component.
